(19) United States
(12) Patent Application Publication
(10) Pub. No.: US 2013/0085800 A1
(43) Pub. Date: Apr. 4, 2013

(54) System and Method of Business Risk Based Authorization

(71) Applicants: John Christopher Radkowski, Los Altos Hills, CA (US); Sarma Adithe Venkata Ram, Cupertino, CA (US)

(72) Inventors: John Christopher Radkowski, Los Altos Hills, CA (US); Sarma Adithe Venkata Ram, Cupertino, CA (US)

(73) Assignee: SAP AG, Walldorf (DE)

(21) Appl. No.: 13/252,036

(22) Filed: Oct. 3, 2011

(51) Int. Cl. G06Q 10/00

(52) U.S. Cl. 705/7.28

(57) ABSTRACT

A system and method of authorizing access in a computer system. The method includes receiving a request to use the computer system, reading authorization data associated with the user, and denying the request according to the authorization data. The method further includes determining a business process risk associated with the request and comparing a characteristic of the request and the business process risk. The method further includes authorizing the request to use the computer system by the user when the business process risk exceeds the characteristic. In this manner, the delay involved in performing the normal access provisioning process is avoided for situations in which the business risk exceeds the cost of the delay.

### CROSS REFERENCE TO RELATED APPLICATIONS

Not applicable.

### BACKGROUND

1. Field of the Invention

The present invention relates to authorizing access to computer systems, and in particular, to improving the responsiveness of authorizing access to computer systems.

2. Description of the Related Art

Unless otherwise indicated herein, the approaches described in this section are not prior art to the claims in this application and are not admitted to be prior art by inclusion in this section.

Many computer systems require authorization for a user to access data managed by the computer system, to use the functionality of the computer system, to interact with the computer system, etc. Often the user will be assigned a login or other identifier. The login may be associated with specific data, tasks or actions the user is authorized to perform. In other systems, the login may be associated with the user's role in the organization (e.g., purchasing manager). The role may be associated with specific data, tasks or actions that the user is authorized to perform by virtue of being associated with that role.

When the user attempts to access data or perform actions that are not authorized, the computer system denies access. If the user believes that the access is needed despite the lack of authorization, the user may request an update of the user's authorization to include the denied access. Often this involves a request to the information technology (IT) staff that manages the computer system, perhaps including oversight or approval by the user's supervisor.

### SUMMARY

Given the above background, often there is a delay between the initial denial of access and the subsequent approval of the access. For example, consider that access may be requested after normal working hours, on the weekend, etc. Further consider that the access request may be part of an important business activity, e.g., an purchase order needs to be generated immediately for a critical component that is going out of production. Thus, there is risk involved in denying access (e.g., the critical component may be unavailable by the time the access is approved), and risk involved in approving access (e.g., the user may generate a fraudulent purchase order). An embodiment of the present invention is directed toward a system that balances the risk involved in failing to perform the action versus the risk of authorizing an otherwise unauthorized action.

One embodiment is a method of authorizing access in a computer system. The method includes receiving a request to use the computer system, reading authorization data associated with the user, and denying the request according to the authorization data. The method further includes determining a business process risk associated with the request and comparing a characteristic of the request and the business process risk. The method further includes authorizing the request to use the computer system by the user when the business process risk exceeds the characteristic. In this manner, the delay involved in performing the normal access provisioning process is avoided for situations in which the business risk exceeds the cost of the delay.

The method may further include receiving a second request from the user to use the computer system and denying the second request according to the authorization data. The method may further include determining a second business process risk associated with the second request, comparing a second characteristic of the second request and the second business process risk, and denying the second request when the second characteristic exceeds the second business process risk. The content of the second request differs from content of the (first) request (e.g., the relevant data access related parameters of the request, not merely that the requests were made at different times or other reasons unrelated to the relevant data access related parameters of the request), resulting in the different risk assessment result than that of the (first) request.

The method may further include receiving a second request, before receiving the (first) request, from the user to use the computer system, and authorizing the second request according to the authorization data. This illustrates the normal operation of an access system (e.g., that does not include a business process risk analysis system as further described below).

The characteristics may include a business process characteristic, a business risk characteristic, a context characteristic, and a prior action characteristic.

The request may correspond to a data object managed by the computer system.

The method may further include authorizing a second request by the user to use the computer system when the authorization data indicates that the user is authorized regarding the second request (e.g., as a result of the authorization data having been updated according to the earlier risk assessment, and the second request is authorized according to the updated authorization data).

The method may further include using, by the user, the computer system according to the request having been authorized. For example, the computer system may include data processing functionality as a main function of the computer system, to which the user now has access as enabled by the access system.

The method may further include determining a role associated with the request, where the role is authorized to use the computer system regarding the request, and where authorizing the request includes assigning the role to the user.

According to an embodiment, a system authorizes access in a computer system. The system includes an access subsystem, a business process risk assessment subsystem, and a risk engine subsystem. The access subsystem is configured to receive a request to use the computer system, to read authorization data associated with the user, and to deny the request to use the computer system according to the authorization data. The business process risk assessment subsystem is configured to determine a business process risk associated with the request. The risk engine subsystem is configured to compare a characteristic of the request and the business process risk, and to authorize the request to use the computer system when the business process risk exceeds the characteristic.

The system may further include a transaction event analysis subsystem that is configured to determine a role based on the request and role data, where the role relates to the characteristic of the request.

The system may further include an authorization rules analysis subsystem that is configured to determine the characteristic based on the request and authorization rules.

The system may further include a provisioning and notification subsystem that is configured to generate a provisioning request when the risk engine subsystem authorizes the request, where the provisioning request updates the authorization data.

The system may further include an other system that is configured to use the access subsystem to grant access to business objects managed by the other system according to the request. The other system may be, for example, a data processing system.

These subsystems may be implemented by computer programs that control the computer system in accordance with the described functionality of the subsystem.

According to an embodiment, a non-transitory computer readable medium stores instructions to control a computer system for authorizing access in the computer system. The instructions include an access component, a business process risk analysis component, and a risk engine component. The instructions may further include a transaction event analysis component, an authorization rules analysis component, a provisioning and notification component, and an other component. These components may operate in a similar manner to the similarly-named subsystems described above.

A computer system may operate to implement the method described above. The computer system may store, execute or be otherwise controlled by one or more computer programs that control the computer system to implement the method described above.

The following detailed description and accompanying drawings provide a better understanding of the nature and advantages of the present invention.

### BRIEF DESCRIPTION OF THE DRAWINGS

FIG. 1 is a block diagram of an access system according to an embodiment.

FIG. 2 is a flowchart of a method of authorizing access in a computer system.

FIG. 3 is a block diagram of an example computer system and network for implementing embodiments of the present invention.

### DETAILED DESCRIPTION

Described herein are techniques for controlling access in a computer system. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain sequence, such sequence is mainly for convenience and clarity. A particular step may be repeated more than once, may occur before or after other steps (even if those steps are otherwise described in another sequence), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

The term “business process risk” generally refers to a risk associated with a business process. The business process risk includes the cost impact of delays in executing the business process. Business process risk may be associated with internal projects, product release projects, financial objectives, etc.

The terms “transaction”, “request” and “access attempt” are used below. In general, these terms are used interchangeably to refer to the process of a user using a computer system. When more precision is desired, the term “access attempt” refers to the initiation of the process of using the computer system, which includes a “request” for the computer system to perform a “transaction”.

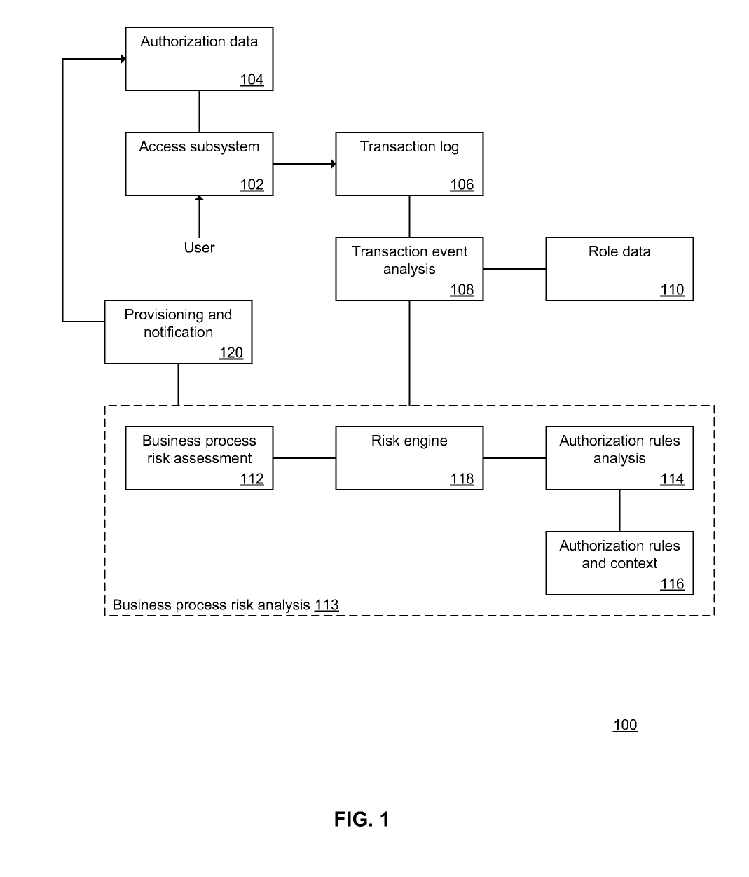

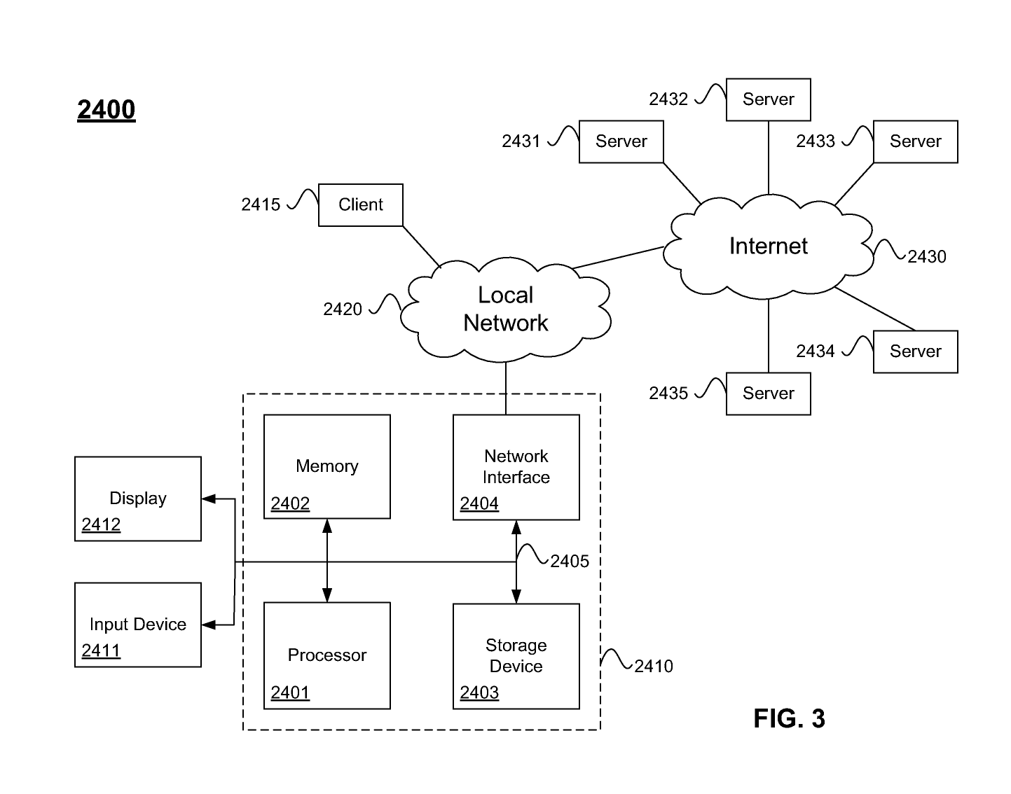

FIG. 1 is a block diagram of an access system 100 according to an embodiment. The access system 100 includes an access subsystem 102, authorization data 104, a transaction log 106, a transaction event analysis subsystem 108, role data 110, a business process risk assessment subsystem 112, an authorization rules analysis subsystem 114, authorization rules and context 116, a risk engine subsystem 118, and a provisioning and notification subsystem 120. The access system 100 may be implemented by one or more computer systems as further detailed below with reference to FIG. 3, for example as controlled by one or more computer programs. More specifically, each subsystem (e.g., the access subsystem 102, the risk engine subsystem 118, etc.) may be implemented by one or more computer programs that are executed by one or more processors, and that access the various data (e.g., the authorization data 104, the transaction log 106, etc.) that is stored by one or more storage devices (e.g., hard drives, etc.). A subsystem implemented by a computer program may be referred to as a component.

The access system 100 is generally part of, or controls access to, a computer system with additional functionality, e.g., a customer relationship management (CRM) system, an enterprise resource planning (ERP) system, a governance, risk management and compliance (GRC) system, etc. This system (or systems) with additional functionality may be referred to as “the other system” when a distinction from the functionality of the access system 100 is desired. More generally, the access subsystem 102, the authorization data 104, and the transaction log 106 may be parts of the other system; they are shown as parts of FIG. 1 to illustrate the connections with the risk assessment components; the components of the other system that are not shown relate to the various types of applications that may be implemented (ERP, GRC, etc.) by the overall system that includes the access system 100 and the other system. According to an embodiment, the access system 100 is part of a SAP NetWeaver™ system.

The access subsystem 102 generally controls access by a user to data stored by the computer system. The access may include reading, writing, changing, editing, deleting, etc. the data. The access may also include instructing the computer system to performing actions or otherwise manipulate the data. The data may include business objects. For example, when the user wants to generate an invoice using an invoicing system (not shown), the access subsystem 102 controls that access. The access subsystem 102 accesses the authorization data 104 when controlling access.

The authorization data 104 generally indicates whether particular users have access to particular data. The authorization data may be stored according to various granularities. At a high level of granularity, the authorization data 104 may limit a user's access to specifically enumerated data. At another level of granularity, data may be organized into sets, and a user may be given access to one or more sets of data. At another level of granularity, the sets may correspond to functions or transactions, and the authorization includes access to all the data required to perform that function. For example, for the function of generating an invoice, the authorization includes the access to the workflow data (to know that the project is completed and can be invoiced) and the accounting data (to know the amount authorized for the project).

The authorization may be role-based. Various roles may be defined, and the various users may be associated with various roles. The role defines the level and type of functions that the user is authorized to perform. For example, the roles of “purchasing manager” and “purchasing submanager” may be defined; both have authorization to access the “generate purchase order” transaction, but the purchasing manager has a cost limit of $100,000 and the purchasing submanager has a cost limit of $10,000.

The transaction log 106 generally stores the transactions authorized by, or denied by, the access subsystem 102. The function of storing denied access attempts is most relevant for the following discussion. According to an embodiment, the transaction log 106 stores the most-recently-failed transaction by a user; the access system 100 then uses the “SU53” transaction in a SAP system to obtain the data of the failed transaction. The SU53 transaction is discussed in more detail below.

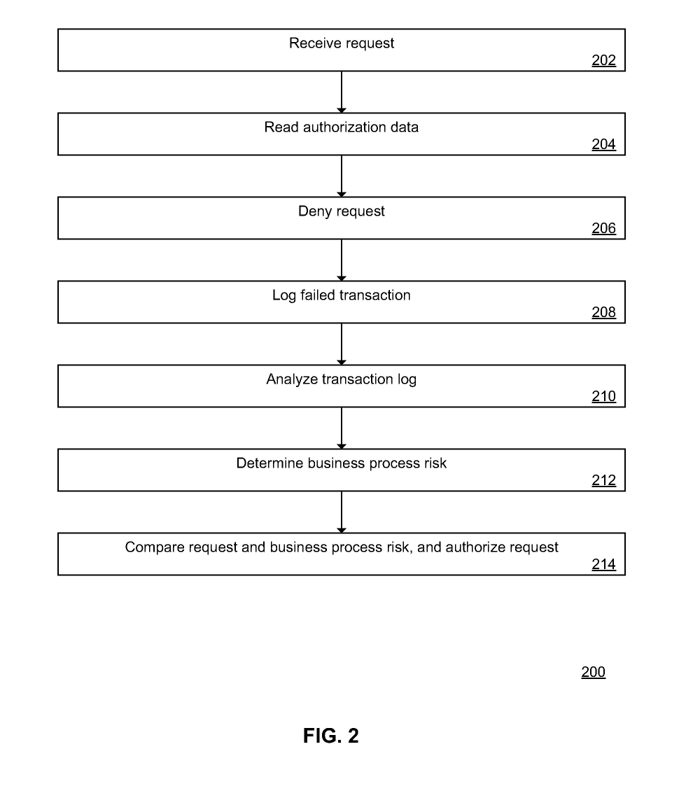

Note that the components described above (e.g., the access subsystem 102) may operate as a standard, existing type of access system (see also 202, 204 and 206 in FIG. 2). The components described below (e.g., the transaction event analysis subsystem 108, the risk engine subsystem 118, etc.) may be used to modify an existing type of access system to add additional functionality (referred to generally as risk-based authorization).

The transaction event analysis subsystem 108 generally analyzes the transactions stored in the transaction log 106. More specifically, when the user's attempt to perform a transaction fails due to lack of authorization (e.g., the access subsystem 102 denies the access based on the authorization data 104), the transaction event analysis subsystem 108 analyzes the failed transaction. According to an embodiment, the transaction event analysis subsystem 108 identifies one or more roles that are granted access to perform the failed transaction. The roles may be stored in the role data 110. The transaction event analysis subsystem 108 identifies the missing authorizations and retrieves the missing authorizations from the role data repository 110. For example, User X is assigned the role “purchasing submanager” and generates a failed transaction by attempting to generate a purchase order for $50,000; the transaction event analysis subsystem 108 uses the role data 110 to identify the role of “purchasing manager” as being authorized to perform that transaction (since as per a previous example, the purchasing submanager has a limit of $10,000 but the purchasing manager has a limit of $100,000).

The business process risk assessment subsystem 112, the authorization rules analysis subsystem 114, and the risk engine subsystem 118 may be collectively referred to as the business process risk analysis system 113. The business process risk analysis system 113 is an application used to incorporate business process risks for application into the access authorization process. This component incorporates the business context with the access risk analysis.

More specifically, the business process risk assessment subsystem 112 generally determines the business risk associated with the business processes performed by the other system (not shown). For example, in an ERP system, key milestones are driven by events in the transactional system such as orders, invoices, shipments, and payments. Business process risks are associated with key milestones and are determined by the impact of a delay. The cost effect of an order not being placed on time, or payment delay for the key activities, are quantified. Business process risks are associated with transactional metrics in the ERP backend and business process steps.

The authorization rules analysis subsystem 114 generally defines and applies the authorization rules and context 116. More specifically, the authorization rules analysis subsystem 114 performs segregation of duties analysis and critical transaction analysis.

The risk engine subsystem 118 generally performs the context based risk analysis and determines the if the weighted risk score of the proposed authorization meets the criteria defined. If so, the risk engine subsystem 118 authorizes the request.

The provisioning and notification subsystem 120 generally interfaces between the business process risk analysis system 113 and the other system to provide and configure the risk-based authorization. According to an embodiment, the other system implements SAP's GRC v10.0, and the provisioning and notification subsystem 120 creates a provisioning request by using the web services interface. The provisioning change may be automated using SAP GRC v10 and the user notified of the change.

The operation of the components of the access system 100, as well as additional details and options, are provided below.

FIG. 2 is a flowchart of a method 200 of authorizing access in a computer system. The method 200 may be performed by a computer system (e.g., the access system 100 of FIG. 1), for example as controlled by one or more computer programs.

At 202, the computer system receives a request to use the computer system. In general the request originates from a user and may be transmitted to the computer system by various components, such as from the user's client computer via a network. In the access system 100 (see FIG. 1), the access subsystem 102 may receive the request from the user.

At 204, the computer system reads authorization data associated with the user. In general, the authorization data defines the access permissions of the user to access data stored by the computer system, the actions the user is allowed to direct the computer system to perform, etc. In the access system 100 (see FIG. 1), the access subsystem 102 reads the relevant authorization data 104 according to the request (see 202).

At 206, the computer system denies the request to use the computer system according to the authorization data. For example, the request requires the user to have certain permissions (that are not met), the request requires the user to have a certain role (that the user lacks), etc. In the access system 100 (see FIG. 1), the access subsystem 102 denies the request when the authorization data 104 indicates that the user is not authorized regarding the user's request.

At 208, the computer system writes the failed transaction to the transaction log 106. The information written to the transaction log 106 may vary according to the embodiment. For example, the transaction log 106 may store the failed request; the transaction log 106 may be part of a more general transaction log for the other system; the transaction log 106 may also store successful transactions; etc. According to an embodiment, the transaction log 106 is implemented as part of a SAP ERP system, in which the failed transaction is accessible via the SU53 transaction.

In a standard computer system (e.g., without the business process risk analysis system 113), at this point when the access is denied, the standard procedure is for the user to contact their manager, the IT staff, etc. or to otherwise inform the system administrators that the user believes the request should be authorized. The organization then follows its procedures for evaluating and approving the access, which results in changes to the authorization data 104. The next time the user makes a similar request, the authorization data 104 then indicates that the request should be approved. However, as discussed above, these procedures for approving the access often take time, which may negatively impact the business process related to the request. The steps below describe how an embodiment addresses this potential negative impact.

At 210, the computer system analyzes the transaction log 106 and identifies the failed request (see 208). The failed request may have various characteristics that the access system extracts and passes on to the business process risk analysis system. In the access system 100, the transaction event analysis subsystem 108 identifies one or more roles that are granted access to perform the failed transaction. Further details of the transaction event analysis subsystem 108 are provided below.

At 212, the computer system determines a business process risk associated with the failed request. The request may relate to an action to be performed using the computer system as part of a business process managed by the computer system. For example, the request may be to generate a purchase order as part of a purchase order process. In the access system 100 (see FIG. 1), the business process risk assessment subsystem 112 determines the business process risk of the failed request identified by the transaction event analysis subsystem 108. Further details of the business process risk assessment subsystem 112 are provided below.

At 214, the computer system compares a characteristic of the request and the business process risk, and authorizes the request to use the computer system by the user when the business process risk exceeds the characteristic. In the access system 100 (see FIG. 1), the risk engine subsystem 118 compares the characteristics of the request (as determined by the transaction event analysis subsystem 108) with the business process risk (as determined by the business process risk assessment subsystem 112). If the business process risk exceeds the characteristic, the risk engine subsystem 118 authorizes the request. As further described below, the risk engine subsystem 118 works with the provisioning and notification system 120 to generate a provisioning request, as part of provisioning the risk-based access.

Note the differences between two similar terms used above: access request and provisioning request. The access request generally refers to a function or data access that the user is requesting the other system to perform. The provisioning request generally refers to the process of updating the authorization data 104 (or other authorization data).

The following examples show how the above process operates using some specific details.

### Example 1

The user initiates a vendor payment transaction to the other system, which the access subsystem 102 denies because of the user assignments in the authorization data 104 (e.g., the requested transaction exceeds the user's defined limits). The transaction log SU53 (e.g., the transaction log 106) is updated with the failed authorization details. The transaction event analysis subsystem 108 reads the transaction log 106, then searches the role data 110 for the missing authorizations (e.g., the role or other permissions that are permitted to perform that transaction). The correct authorization is found, enabling a larger payment limit based on the risk determined by the risk engine 118 using the business process risk assessment subsystem 112 and the authorization rules analysis subsystem 114. The authorization rules analysis subsystem 114 performs analysis of the (proposed) new authorization assignment based on the data in the authorization rules and context 116. Then the provisioning and notification subsystem 120 updates the authorization data 104 and notifies the user that their payment limit is updated.

### Example 2

The normal process (e.g., without an embodiment of the invention) is that the user makes a request and the request is denied; the user then contacts the system administrators to update the user's permissions. This process can take several hours to several weeks. During this time, the user is unable to process transactions, order material, process payments, and support the business processes. This delay has a cost impact on the overall business process that is depending upon the requested access by the user. By adding in the business process risk analysis system 113 and related components, the cost impact on the overall business process may be determined by the business process risk assessment subsystem 112.

The assignment update may then be updated—without the delay involved from requiring approval by system administrators—based on the risk as assessed by the authorization rules analysis subsystem 114.

Further details regarding the components of the system and the operation of the system are provided below.

Transaction Event Analysis Subsystem 108

As discussed above, the transaction event analysis subsystem 108 analyzes the failed transaction and identifies one or more roles that are granted access to perform the failed transaction. The transaction event analysis subsystem 108 determines the role or creates a new one that provides the correct authorization, using the role data 110.

According to an embodiment, the role data 110 is stored in the other system. For example, the other system is an ERP system and the role data 110 is used by the ERP system when performing its normal ERP functionality. The transaction event analysis subsystem 108 then accesses the role data 110 in order to perform its function. As a specific example, when the other system is a SAP ERP system, the role data is accessible in transaction PFCG. For other embodiments that interface with other systems, the role data is accessible in various other ways according to the specifics of the other system.

Besides roles, other ways may be implemented for determining the appropriate level of access to approve. For example, a role is a specific type of a general class referred to as entitlements. Entitlements are used to relate users and actions (or data). Entitlements may consist of may types of objects, which may include roles, profiles, groups, attributes, rules, etc. Thus, the specific implementation of the transaction event analysis subsystem 108 may vary depending upon the specific implementation of the entitlements (as stored as the role data 110).

SU53 Transaction

As discussed above, the SU53 transaction is one way for the transaction event analysis subsystem 108 to detect denied access requests, for further processing by the business process risk analysis system 113. In SAP system environments, the SU53 transaction is passed a identifier for a user and returns the most recently denied access request. Other embodiments may use other options for identifying failed transactions, for example event logs, audit trails, security incident and event management (SIEM) systems, etc. This information may be stored in the transaction log 106 as part of the normal operation of the other system.

SU53 is a specific transaction in SAP ERP that provides a summary of a failed authorization. SU53 is a good example to illustrate an embodiment of the business process risk analysis system 113, to use the SU53 summary to determine which role was assigned, then identify the roles or “entitlements” needed to be assigned to complete the function. SU53 is specific to SAP ERP, however other applications have event logs, audit trails, or other data that is similar. The transaction event analysis subsystem 108 reads this information to determine which entitlements are required to be assigned temporarily (or even permanently) to the user.

Business Process Risk Assessment Subsystem 112

As discussed above, the business process risk assessment subsystem 112 determines the business risk associated with the failed request. More specifically, business process risks apply to a combination of business scenarios that include business continuity, business processes, project milestones, etc. Failed or incorrect authorization is responsible for many delays that impact everything from processing expense reports to ordering materials for a business critical process. Other scenarios include dynamically applying the correct authorization to enable a user to troubleshoot and make critical configuration changes necessary to restore system operations.

One example has to do with ordering material—a user attempts to order material for to meet a deadline associated with manufacturing a product. The business risk associated with missing the deadline is significant. With the risk modeled in the system, a user attempts to order material, and the authorization is denied; but since the business impact of this delay is large (e.g., $100M), the transaction is granted dynamically, to enable the ordering to proceed. The business risk and impact is stored in an audit log (e.g., managed by the provisioning and notification subsystem 120) and user and business process owners are notified.

### Characteristics

As discussed above, the transaction event analysis subsystem 108 identifies the characteristics of the failed request. The transaction event analysis subsystem 108 analyzes the failed authorization log, audit trail, or SU53 (e.g., the transaction log 106), then determines the missing authorizations. The business process risk assessment subsystem 112 provides the business risk analysis of the new authorization assignments. These characteristics may include a business process characteristic, a business risk characteristic, a context characteristic, and a prior action characteristic. The business process characteristic generally refers to the business function that the user is requesting the system to perform. The transaction event analysis subsystem 108 may include other context and behavior as stored as the role data 110. The business risk characteristic refers to the attributes and definition of the business risk (e.g., risk of shipment delay, risk of manufacturing stoppage, risk of slipping delivery or project milestone, risk of compliance fine, etc.). The context characteristic refers to evaluating the conditions under which the request is made (e.g., the specific business process, the user ID, the machine ID, location, etc.). The prior action characteristic refers to the evaluation of the user's transaction history to determine if the access request conforms to the user's past behavior. The use of each of these characteristics, as well as the weights assigned and the aggregation formula used, may depend upon the nature of the information stored in the transaction log 106 or otherwise provided by the other system.

Authorization Rules Analysis 114 and Risk Engine 118

Once the transaction analysis is completed, the authorization rules analysis subsystem 114 performs authorization analysis and business process risk analysis on the new roles that are to be assigned and the existing roles that the user already has. The risk analysis engine 118 executes rules that evaluate the transaction, business risk, and authorization risk to decide if the transaction is allowed. The risk is evaluated using the business process, context, prior transaction history (e.g., is the user a member of the organization responsible for this function), etc. The criteria that may be applied to the decision, as well as the definition of the risk, may be implemented using a framework that enables customers to define the objects and values. This can happen in real-time or via an approval process.

As discussed above, the risk engine subsystem 118 compares the characteristics of the request (as determined by the transaction event analysis subsystem 108) with the business process risk (as determined by the business process risk assessment subsystem 112). For example, the risk engine subsystem 118 may evaluate the business process risk and the authorization risk. The risk engine subsystem 118 may compute a weighted sum of these risks to determine if a threshold is met.

As an example, assume that the business process risk analysis is based on an evaluation of the following values: if business risk=critical, and financial impact is >$5000, and prior action=normal, and context=secure, and organization=manufacturing, and location=Portland, and assigned role criticality=medium, then business risk=LOW (calculated based on above). This allows organizations to tune the level of risk that is acceptable compared with the business risk. Presumably, if the business risk or impact is low, and new role criticality or sensitivity is low, then it is permissible to assign the role to the user.

Provisioning Request

As discussed above, according to an embodiment, the other system implements SAP's GRC v10.0, and the provisioning and notification subsystem 120 creates a provisioning request by using the web services interface. More specifically, the provisioning and notification subsystem 120 modifies the user's assignments or authorizations in the authorization data 104 (as part of the SAP Business Objects Access Control system, according to an embodiment). According to another embodiment, the provisioning and notification subsystem 120 performs an update to the authorization data 104, and informs the other system that the update has occurred (for performing review, verification, approval, etc. of the risk-based authorization). According to yet another embodiment, the provisioning and notification subsystem 120 sends a provisioning request to the other system, which itself performs an update to the authorization data 104.

Once the authorization data 104 has been updated, the access subsystem 102 re-checks the request against the (updated) authorization data 104. Thus, although the request was originally denied, since the potential business process impact of the denial exceeds the calculated risk (see 214), the access subsystem 102 now approves the request. The access may be equivalent to that which would have been provided had the request not been initially denied.

Also as discussed above, the provisioning and notification system 120 may, as part of generating the provisioning request, may send a notification through the normal provisioning request channels that the risk-based authorization has occurred. For example, if the normal process for requesting a higher authorization level is for the user to submit a form to the user's supervisor for approval then sending the approved form to systems administration for updating the authorization data 104, then the provisioning and notification system 120 may send a modified form to the user's supervisor noting that the risk-based authorization has occurred, with a request for review and approval (or denial and revocation of the risk-based authorization) by the supervisor, etc.

FIG. 3 is a block diagram of an example computer system and network 2400 for implementing embodiments of the present invention. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM) (when not storing temporary variables or other intermediate information), or both. A storage device 2403 is also provided for storing information and instructions. Common forms of storage devices include, for example, a hard drive, a magnetic disk, an optical disk, a CD-ROM, a DVD, a flash memory, a USB memory card, a solid state drive, or any other medium from which a computer can read. Storage device 2403 may store source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to an Intranet or the Internet 2430. In the Internet example, software components or services may reside on multiple different computer systems 2410 or servers 2431, 2432, 2433, 2434 and 2435 across the network. A server 2431 may transmit actions or messages from one component, through Internet 2430, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, as described above, the user (see FIG. 1) may use the client 2415 to access the access system 100 and the other system. The access system 100 may be implemented by the server 2431, which includes components similar to those of the computer system 2410. The other system may include a SAP ERP system that is implemented by the server 2432 and a SAP GRC system that is implemented by the server 2433, both of which includes components similar to those of the computer system 2410. Alternatively, the server 2434 may implement both the access system 100 and the other system (in which case the server 2434 includes components similar to those of the computer system 2410).

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method of authorizing access in a computer system, comprising:
receiving, by the computer system from a user, a request to use the computer system;
reading, by the computer system, authorization data associated with the user;
denying the request to use the computer system by the user according to the authorization data;
determining a business process risk associated with the request;
comparing a characteristic of the request and the business process risk; and
authorizing the request to use the computer system by the user when the business process risk exceeds the characteristic.

2. The method of claim 1, further comprising:
receiving a second request from the user to use the computer system, wherein content of the second request differs from content of the request;
denying the second request according to the authorization data;
determining a second business process risk associated with the second request;
comparing a second characteristic of the second request and the second business process risk; and
denying the second request when the second characteristic exceeds the second business process risk.

3. The method of claim 1, further comprising:
receiving a second request, before the request, from the user to use the computer system, wherein content of the second request differs from content of the request; and
authorizing the second request according to the authorization data.

4. The method of claim 1, wherein the characteristics include at least one of a business process characteristic, a business risk characteristic, a context characteristic, and a prior action characteristic.

5. The method of claim 1, wherein the request corresponds to a data object managed by the computer system.

6. The method of claim 1, further comprising:
authorizing a second request by the user to use the computer system when the authorization data indicates that the user is authorized regarding the second request, wherein content of the second request differs from content of the request.

7. The method of claim 1, further comprising:
using, by the user, the computer system according to the request having been authorized.

8. The method of claim 1, further comprising:
determining a role associated with the request, wherein the role is authorized to use the computer system regarding the request,
wherein authorizing the request includes assigning the role to the user.

9. A system for authorizing access in a computer system, comprising:
an access subsystem that is configured to receive, by the computer system from a user, a request to use the computer system,
wherein the access subsystem is configured to read authorization data associated with the user, and
wherein the access subsystem is configured to deny the request to use the computer system by the user according to the authorization data;
a business process risk assessment subsystem that is configured to determine a business process risk associated with the request; and
a risk engine subsystem that is configured to compare a characteristic of the request and the business process risk,
wherein the risk engine subsystem is configured to authorize the request to use the computer system by the user when the business process risk exceeds the characteristic.

10. The system of claim 9, further comprising:
a transaction event analysis subsystem that is configured to determine a role based on the request and role data, wherein the role relates to the characteristic of the request.

11. The system of claim 9, further comprising:
an authorization rules analysis subsystem that is configured to determine the characteristic based on the request and authorization rules.

12. The system of claim 9, further comprising:
a provisioning and notification subsystem that is configured to generate a provisioning request when the risk engine subsystem authorizes the request, wherein the provisioning request updates the authorization data.

13. The system of claim 9, further comprising:
an other system that is configured to use the access subsystem to grant access to business objects managed by the other system according to the request.

14. The system of claim 9, wherein the access subsystem is configured to receive a second request, before the request, from the user to use the computer system, wherein content of the second request differs from content of the request; and
wherein the access subsystem is configured to authorize the second request according to the authorization data.

15. A non-transitory computer readable medium storing instructions to control a computer system for authorizing access in the computer system, comprising:
an access component that is configured to control the computer system to receive, from a user, a request to use the computer system,
wherein the access component is configured to control the computer system to read authorization data associated with the user, and
wherein the access component is configured to control the computer system to deny the request to use the computer system by the user according to the authorization data;
a business process risk analysis component that is configured to control the computer system to determine a business process risk associated with the request; and
a risk engine component that is configured to control the computer system to compare a characteristic of the request and the business process risk,
wherein the risk engine component is configured to control the computer system to authorize the request to use the computer system by the user when the business process risk exceeds the characteristic.

16. The non-transitory computer readable medium of claim 15, further comprising:
a transaction event analysis component that is configured to control the computer system to determine a role based on the request and role data, wherein the role relates to the characteristic of the request.

17. The non-transitory computer readable medium of claim 15, further comprising:
an authorization rules analysis component that is configured to control the computer system to determine the characteristic based on the request and authorization rules.

18. The non-transitory computer readable medium of claim 15, further comprising:
a provisioning and notification component that is configured to control the computer system to generate a provisioning request when the risk engine component authorizes the request, wherein the provisioning request controls the computer system to update the authorization data.

19. The non-transitory computer readable medium of claim 15, further comprising:
an other component that is configured to control the computer system to use the access subsystem to grant access to business objects managed by the other component according to the request.

20. The non-transitory computer readable medium of claim 15, wherein the access component is configured to control the computer system to receive a second request, before the request, from the user to use the computer system, wherein content of the second request differs from content of the request; and
wherein the access component is configured to control the computer system to authorize the second request according to the authorization data.
